(19) United States
(12) Patent Application Publication
(10) Pub. No.: US 2024/0392836 A1
(43) Pub. Date: Nov. 28, 2024

(54) BEARING HOUSING ASSEMBLIES FOR SOLAR TRACKERS

(71) Applicant: Nextracker LLC, Fremont, CA (US)

(72) Inventors: Abhimanyu Anil Sable, Hyderabad (IN); Alexander W. AU, Oakland, CA (US); Ashwajit Wahane, Kalyan (IN); Jitendra Morankar, Hyderabad (IN); Phani Kumar, Hyderabad (IN); Raghavendra Praveen Maddulapalli, Vijayawada (IN); Ricardo Delgado-Nanez, San Jose, CA (US)

(21) Appl. No.: 18/669,602

(22) Filed: May 21, 2024

Related U.S. Application Data
(60) Provisional application No. 63/468,605, filed on May 24, 2023.

(51) Int. Cl. F16C 35/02; F16C 17/02; F16C 33/20

(52) U.S. Cl. CPC F16C 35/02; F16C 17/02; F16C 33/20

(57) ABSTRACT

Coupling assemblies for use with solar trackers include a housing, a bearing, and at least one hard stop. The housing includes a circular aperture and protruding members extending from the housing. The bearing fits within the circular aperture and rotate within the circular aperture of the housing. The bearing includes an aperture having the shape of the cross-section of a torque tube. The hard stop engages with the protruding members to limit rotation of the bearing and torque tube to a preconfigured articulation range. The housing may include opposing ball bearing paths disposed along an inner surface of the circular aperture, and hard stops at end portions of the opposing ball bearing paths. The bearing may include ball bearing races in an outer portion of the bearing. The coupling assembly may include ball bearings configured to move in the ball bearing paths and the ball bearing races.

### RELATED APPLICATIONS

This application claims the benefit of U.S. Provisional Patent Application No. 63/468,605, filed May 24, 2023, the entire contents of which are incorporated herein by reference.

### FIELD

This disclosure relates to solar power generation systems, and more particularly, to couplings for accommodating misalignment and thermal expansion of torque tubes of solar trackers.

### BACKGROUND

To follow the trajectory of the sun, solar trackers mount solar modules on torque tubes which is rotatably supported on a plurality of piers. During operation of the solar tracker, thermal fluctuations occur daily and seasonably resulting in thermal expansion and contraction of the solar tracker components. In many instances, the thermal expansion is not great enough to impart significant forces on individual components. However, the torque tubes of the solar trackers can be relatively long, which results in significant expansion and contraction during daily and seasonal temperature fluctuations.

The thermal expansion and contraction of the torque tubes can impart significant axial loads on the support structures. The torque tubes of the solar tracker are rotatably supported on the piers by a coupling. These couplings enable the torque tube to rotate about its longitudinal axis and in many cases, enable the torque tube to axially slide within the coupling to accommodate thermal expansion and contraction of the torque tube.

Axial movement of the torque tube can impart significant loads on the couplings and the piers supporting them. Axial forces due to expansion and contraction of the torque tube can cause the piers to deflect or otherwise deform to accommodate this axial movement by the torque tube. This deflection by the piers can cause misalignment of the couplings with respect to the torque tubes, which can cause increased friction or binding of the torque tube as the torque tube is rotated within the couplings. This binding or increased friction increases the amount of force required to rotate the torque tube, which in turn, imparts increased loads on the actuators or motors effectuating the rotation. In some instances, as the actuators or motors impart more rotational force on the torque tube, the torque tube may twist along its length, causing some solar panels to rotate more or less than other solar panels along the length of the torque tube.

### SUMMARY

In accordance with one aspect of the disclosure, a coupling assembly for use with a solar tracker includes a housing, a bearing, and at least one hard stop. The housing includes a circular aperture and protrusions extending from the housing. The bearing is configured to fit within the circular aperture and to rotate within the circular aperture of the housing. The bearing includes an aperture having a shape of a cross-section of a torque tube. The at least one hard stop is configured to engage with the protrusions and limit motion of the bearing.

In aspects, the housing may be a stamped metal sheet. In aspects, the housing may include a first base member and a second base member defining a first arc, and a top member defining a second arc. In aspects, the end portions of the top member may be configured to couple between the first base member and the second based member to form an aperture.

In aspects, the shape of the cross-section of the torque tube may be a circular shape, a rectangular shape, a hexagonal shape, an octagonal shape, a D-shape, a triple D-shape, or a square shape.

In aspects, the at least one hard stop may be a wrench-type hard stop that couples to a side surface of the bearing or a bearing-clip hard stop that clips across an outside surface of the bearing. In other aspects, the at least one hard stop may be a link hard stop configured to couple to the torque tube.

In accordance with another aspect of the disclosure, a coupling assembly for use with a solar tracker includes a housing, a bearing, and ball bearings. The housing includes a circular aperture, a pair of opposing ball bearing paths disposed along an inner surface of the circular aperture, and hard stops at end portions of the pair of opposing ball bearing paths. The bearing is configured to fit within the circular aperture and to rotate within the circular aperture of the housing. The bearing includes an aperture having a shape of the cross-section of a torque tube. The bearing also includes ball bearing races in an outer surface of the bearing. The ball bearings are disposed between the bearing paths and the bearing races.

In aspects, the bearing may be made of a polymer material. In aspects, the bearing may be a split bearing or a single-piece bearing.

In aspects, the housing may include a first housing member and a second housing member, each including opposing pairs of ball bearing paths and hard stops at end portions of the ball bearing paths. In aspects, the housing may include a first housing member and a second housing member configured to be coupled together.

In accordance with another aspect of the disclosure, a seismic resistant coupling assembly for use with a solar tracker includes a housing, a bearing, and a pair of adapters. The housing has an A-shaped profile. The housing includes a circular aperture and a pair of mounting feet. The bearing is configured to fit within the circular aperture and to rotate within the circular aperture of the housing. The bearing includes an aperture having a shape of the cross-section of a torque tube. The pair of adapters include walls defining an aperture and a flange configured to couple to opposite sides of the bearing. The aperture has a shape of the cross-section of a torque tube. The inner portion of the walls are configured to couple to a torque tube.

In aspects, the seismic resistant coupling assembly may include a link hard stop that may be configured to couple to the torque tube. In aspects, the housing may include protruding members configured to engage with the link hard stop and prevent further motion of the torque tube.

In aspects, the shape of the cross-section of the torque tube may be a circular shape, a rectangular shape, a hexagonal shape, an octagonal shape, a D-shape, a triple D-shape, or a square shape.

In aspects, the housing may be made of a metallic material. In aspects, the bearing may be made of a polymer material.

### BRIEF DESCRIPTION OF THE DRAWINGS

Various aspects and features of the disclosure are described hereinbelow with reference to the drawings, wherein:

FIG. 1 is a perspective view of a solar tracker provided in accordance with the disclosure;

FIG. 2 is a perspective view of an example of a torque tube coupling assembly including wrench-type hard stops for use in the solar tracker of FIG. 1;

FIG. 3 is an exploded view of the torque tube coupling assembly of FIG. 2;

FIGS. 4A and 4B are side views of a torque tube at maximum articulation in the torque tube coupling assembly of FIG. 2;

FIGS. 5A and 5B are perspective views of prototypes of the torque tube coupling assembly of FIG. 2;

FIG. 6 is a perspective view of an example of a torque tube coupling assembly including link-type hard stops for use in the solar tracker of FIG. 1;

FIG. 7 is an exploded view of the torque tube coupling assembly of FIG. 6;

FIGS. 8A and 8B are side views of a torque tube at maximum articulation in the torque tube coupling assembly of FIG. 6;

FIG. 9 is a perspective view of an example of a torque tube coupling assembly including bearing-clip-type hard stops for use in the solar tracker of FIG. 1;

FIG. 10 is an exploded view of the torque tube coupling assembly of FIG. 9;

FIGS. 11A and 11B are side views of a torque tube at maximum articulation in the torque tube coupling assembly of FIG. 9;

FIG. 12 is a perspective view of an example of a torque tube coupling assembly including link hard stops for use in the solar tracker of FIG. 1;

FIG. 13 is a side view of an example of a serviceable torque tube coupling assembly for use in the solar tracker of FIG. 1;

FIG. 14 is a perspective view of the housing of the serviceable torque tube coupling assembly of FIG. 13;

FIG. 15 is a perspective view of an example of a torque tube coupling assembly including an external hard stop for use in the solar tracker of FIG. 1;

FIG. 16 is a perspective view of the housing of the torque tube coupling assembly of FIG. 15;

FIG. 17 is a side view of an example of a torque tube coupling assembly including a non-frictional ball bearing adapter for use in the solar tracker of FIG. 1;

FIG. 18 is a perspective view of the non-frictional ball bearing adapter of the torque tube coupling assembly of FIG. 17;

FIG. 19 is a perspective view of an example of a dual ball bearing torque tube coupling assembly for use in the solar tracker of FIG. 1;

FIGS. 20A and 20B are side views of a torque tube at maximum articulation in the dual ball bearing torque tube coupling assembly of FIG. 19;

FIG. 21 is a perspective view of an example of a non-frictional ball bearing for a torque tube coupling assembly for use in the solar tracker of FIG. 1;

FIG. 22 is an exploded view of the non-frictional ball bearing and the torque tube coupling assembly of FIG. 21;

FIG. 23A is a perspective view of the non-frictional ball bearing of FIG. 21 assembled on a torque tube;

FIG. 23B is a perspective view of the torque tube coupling assembly of FIG. 21 being assembled around the non-frictional ball bearing of FIG. 21;

FIG. 24 is a perspective view of an example of a seismic-resistant torque tube coupling assembly for use in the solar tracker of FIG. 1;

FIG. 25 is an exploded view of the seismic-resistant torque tube coupling assembly of FIG. 24; and

FIGS. 26A and 26B are side views of a torque tube at maximum articulation in the seismic-resistant torque tube coupling assembly of FIG. 24.

### DETAILED DESCRIPTION

This disclosure is directed to various coupling systems for use with a solar tracker. The coupling systems, which are also referred to as bearing housing assemblies, generally include a housing or a housing assembly, a bearing or bearing assembly, and one or more one hard stops, hard stop paths, or adapters. The housing or housing assembly includes a circular aperture configured to receive a circular bearing, which, in turn, includes an aperture with a cross-section that matches the cross-section of the torque tube. The circular bearing may be made of a polymer material and is configured to provide sufficient friction for damping during the movement of the torque tube. The one or more one hard stops or hard stop paths are configured to limit the articulation range of the solar tracker's torque tube. The housing assembly may include a pair of housing members, which may be formed using a stamping method and which may be coupled to each other. The housing assembly may include one or more protruding members, with which the one or more hard stops engage with to limit the motion of the torque tube between two maximum tracking angles.

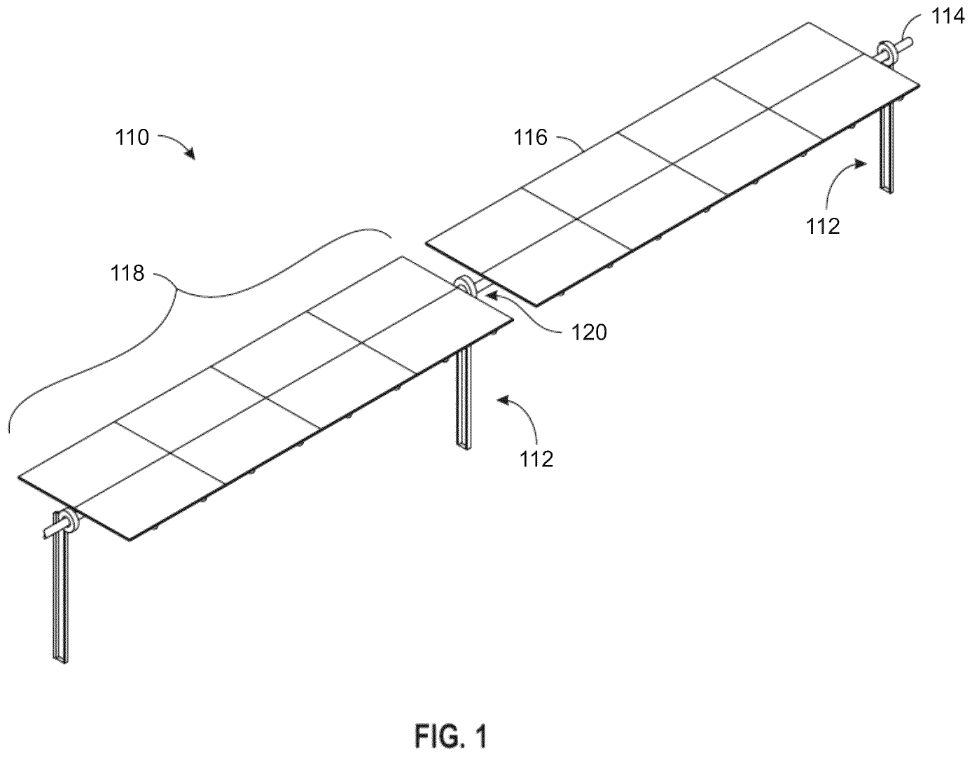

Referring now to the drawings, a solar tracker 110 provided in accordance with this disclosure is illustrated in FIG. 1 and generally identified by reference numeral 110. The solar tracker 110 includes multiple piers 112 disposed in spaced relation to one another and embedded in the earth. A torque tube 114 extends between each adjacent pier 112 and is rotatably supported on each pier 112. The torque tube 114 is rotatably supported on each pier 112 by a coupling assembly or bearing housing assembly (BHA) 120, a slew drive (not shown), amongst others. In one non-limiting aspect, the torque tube is rotatably supported on each pier 112 by a respective BHA 120, which is fastened or attached to each pier 112, as will be described in further detail hereinbelow.

The solar tracker 110 includes multiple solar panels 116 supported on each respective torque tube 114. The span between two adjacent piers 112 is referred to as a bay 118 and may be generally in the range of about 8 meters in length. Multiple solar trackers 110 may be arranged in a north-south longitudinal orientation to form a solar array.

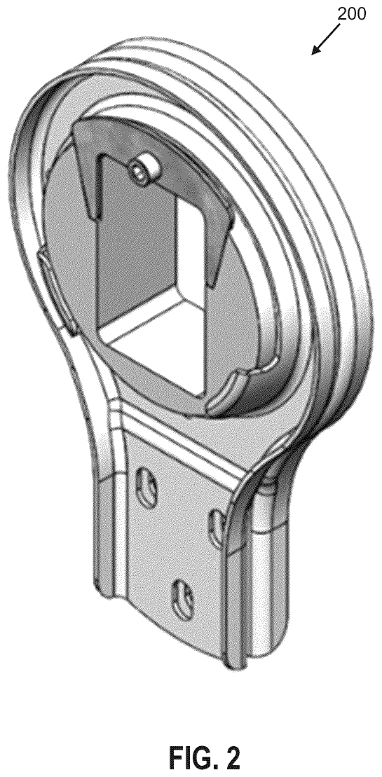

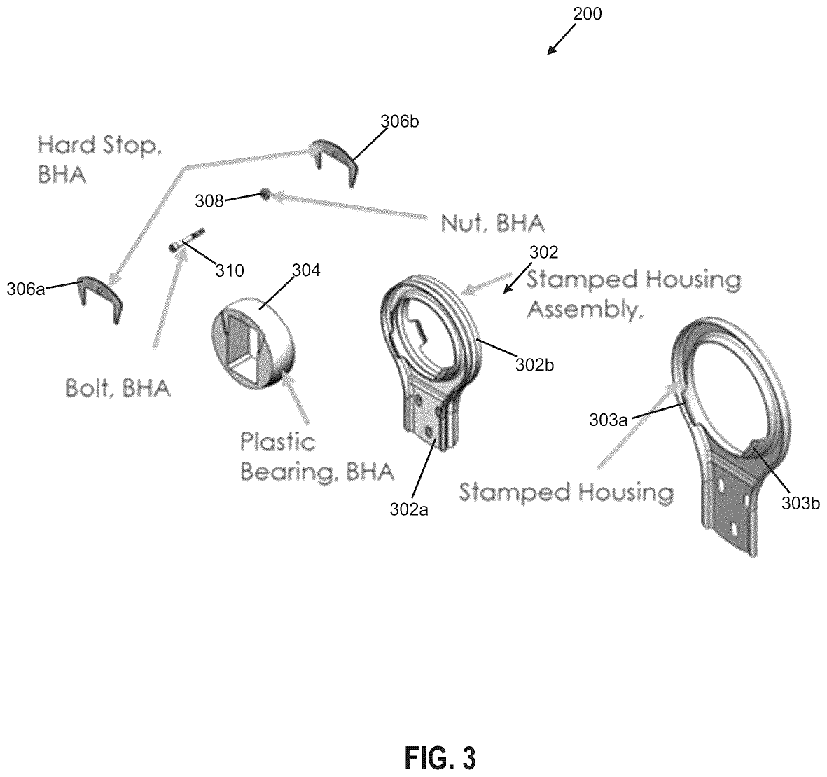

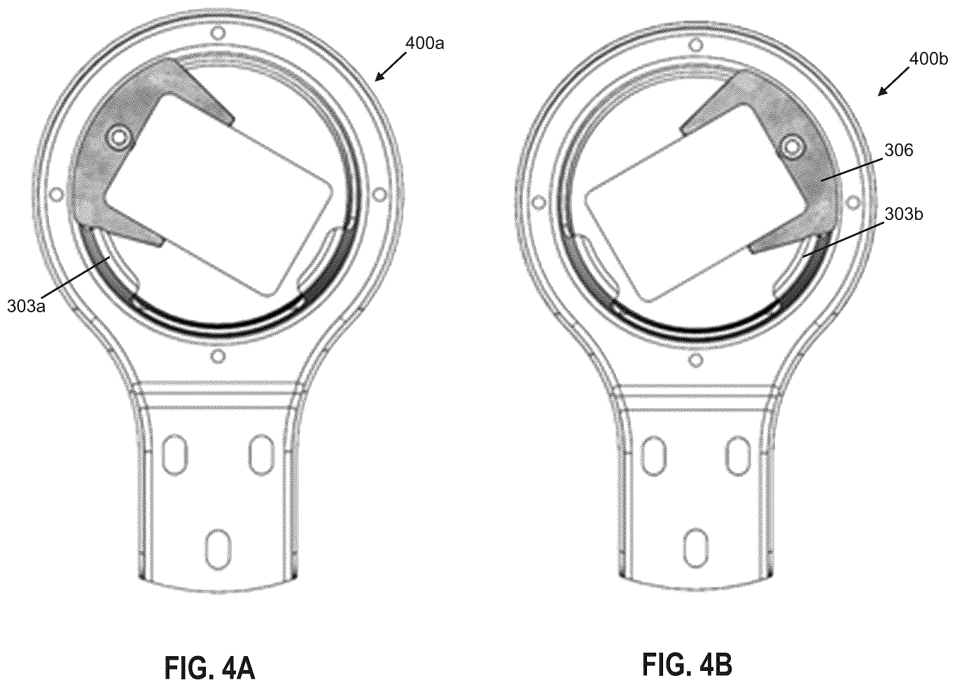

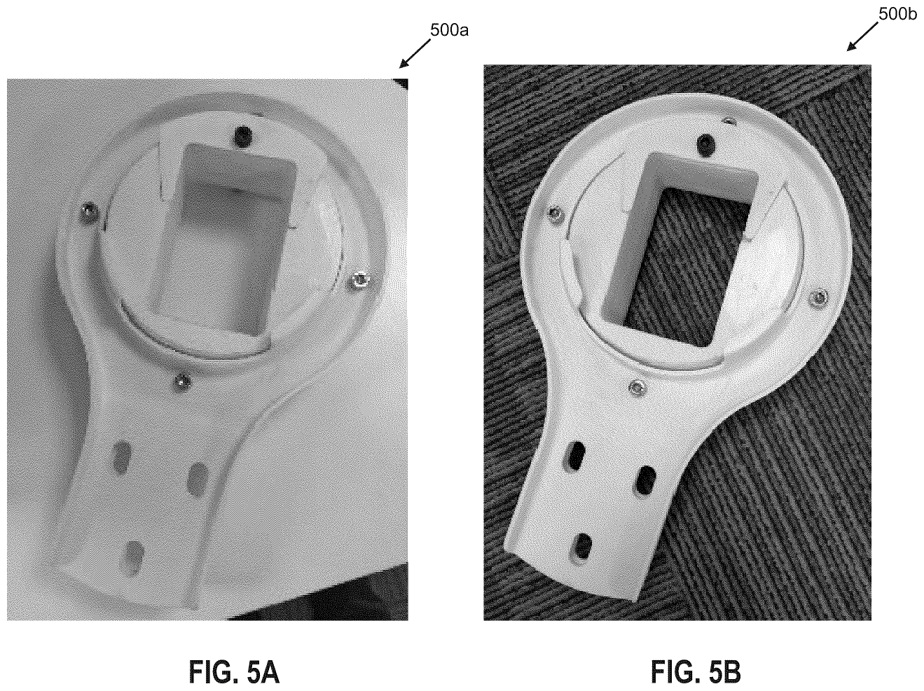

FIGS. 2-5B illustrate the structure and function of an example of a torque tube coupling assembly 200 including wrench-type hard stops 306a, 306b for use in the solar tracker 110 of FIG. 1. The coupling assembly 200 includes a housing assembly 302, which may include a first housing member 302a and a second housing member 302b. The base of the first and second housing members 302a, 302b may be coupled to a pier 112 using any suitable method and/or structure, such as fasteners, welding, adhesives, amongst others. Alternatively, the base of the first and second housing members 302a, 302b may be coupled to a pier 112 via a mounting bracket (not shown) using any suitable mounting method, such as via fasteners, welding, adhesives, amongst others.

The first and second housing members 302a, 302b may each be formed by stamping a sheet of metal or other suitable sheet of material for stamping a desired housing pattern. The first and second housing members 302a, 302b are coupled to and disposed in juxtaposed relationship to one another. Each of the first and second housing members 302a, 302b may include a first protrusion or protruding member 303a and a second protrusion or protruding member 303b. The first and second protruding members 303a, 303b may be formed in a stamping process. The coupling assembly 200 may also include a bearing 304, which is shaped to fit and rotate within an aperture of the housing assembly 302, and which includes an aperture shaped to receive a torque tube. The bearing 304 may be made of plastic or other suitable polymer material. The bearing 304 may be formed as a unitary component by machining and additive manufacturing, amongst others, or in aspects, may be formed from one or more components joined together via welding, fasteners, adhesives, amongst others.

The coupling assembly 200 may also include a first wrench-type hard stop 306a and a second wrench-type hard stop 306b, which are configured to couple to opposite sides of the bearing 304. The first and second wrench-type hard stops 306a, 306b may attach to opposite sides of the housing assembly 302 via a nut 308 and a bolt 310. The bolt 310 may pass through apertures in the first wrench-type hard stop 306a, the bearing 304, and the second wrench-type hard stop 306b, and the nut 308 may be rotated on a threaded portion of the bolt 310 to couple the first hard stop 306a, the bearing 304, and the second wrench-type hard stop 306b together.

It is contemplated that the bolt 310 or any other bolt of or used in conjunction with the coupling assemblies described herein may be any suitable fastener, such as a cap screw, a threaded rod, an unthreaded rod, amongst others. It is also contemplated that the nut 308 or any other nut of or used in conjunction with the coupling assemblies described herein may be any suitable fastener, such as a flange nut or lock nut, amongst others.

The coupling assembly 200 facilitates the movement of the torque tube through the range of articulation of the solar tracker 110. When the maximum articulation is reached the wrench-type hard stops 306a, 306b engage with one of the first and second protruding members 303a, 303b of the housing assembly 302. The excess load is transferred to the foundation pile (not shown) through the coupling assembly 200. The housing assembly 302 may be manufactured through any suitable method including stamping. The first and second housing members 302a, 302b may be assembled to form the housing assembly 302. The first and second housing members 302a, 302b may be assembled using riveting, e.g., tox-riveting, to form the housing assembly 302.

A bearing 304, which may be made of a polymer material, may be used between the housing assembly 302, which may be made of metal, and the torque tube. The bearing 304 creates frictional damping during movement of the torque tube. The geometry of the bearing 304 may be changed depending on the cross-sectional shape of the torque tube. The wrench-type hard stops 306a, 306b are on the coupling assembly 200 so that at maximum articulation the wrench-type hard stops 306a, 306b hit one of the first and second protruding members 303a, 303b. The coupling assembly 200 may be installed on a pier 112 directly with fasteners through slots, e.g., elliptical slots.

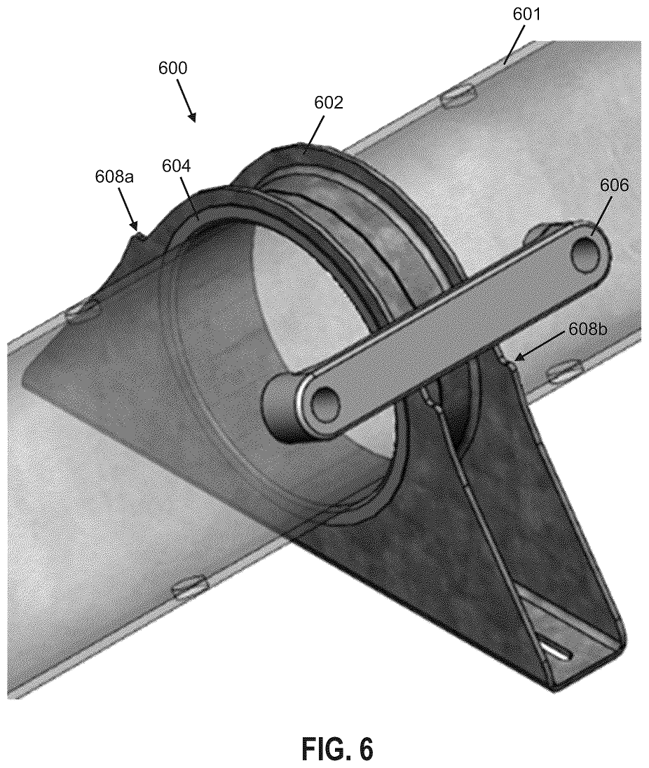

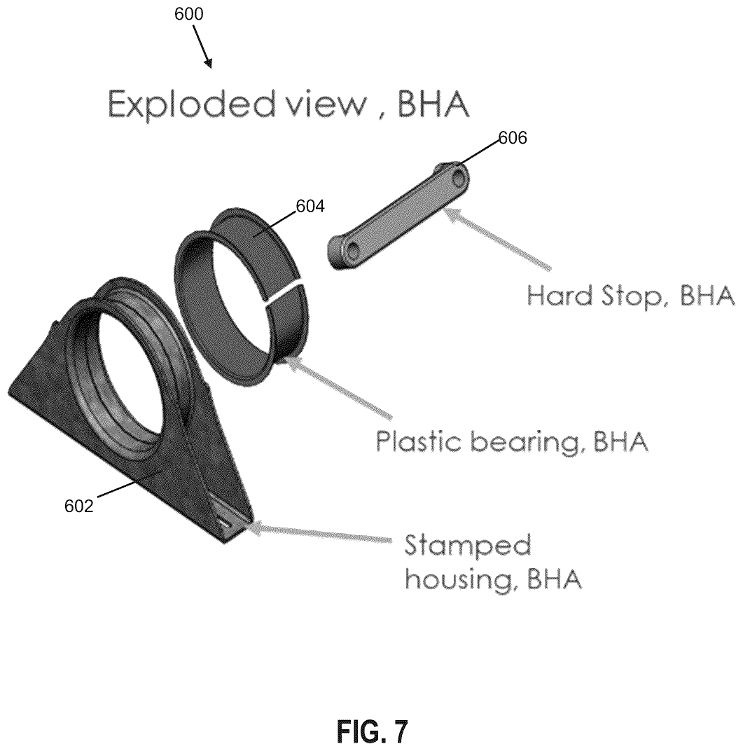

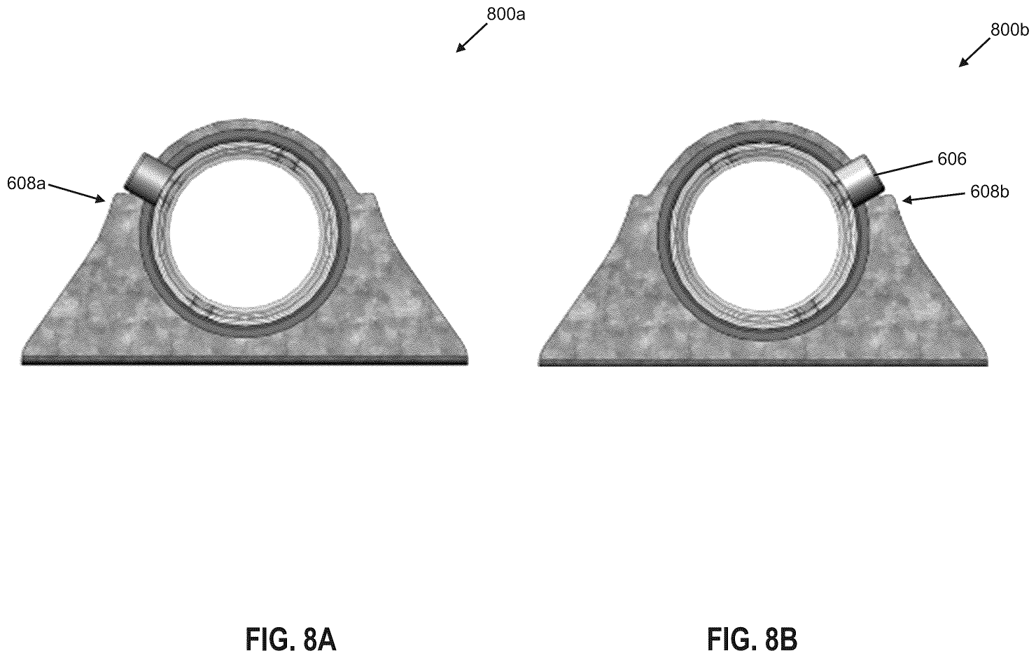

FIGS. 6-8B illustrate the structure and function of an example of a cylindrical torque tube coupling assembly 600 including link-type hard stops for use in the solar tracker 110 of FIG. 1. The cylindrical torque tube coupling assembly 600 includes a housing 602, a bearing 604, and a hard stop 606 coupled to a cylindrical torque tube 601. As shown in FIG. 6, the hard stop 606 may be coupled to the cylindrical torque tube 601 across the cylindrical torque tube coupling assembly 600.

The housing 602 may be made of metal or a metal alloy, and may be manufactured through different methods including, for example, stamping. In other aspects, the housing 602 may be modified according to the geometry or cross-section of the torque tube. For example, the aperture of the bearing 604 may be shaped to receive and fit a torque tube with a square or rectangular cross-section. The bearing 604 may be made of polymer material or any suitable material used between the inner surface of the housing 602 and the torque tube to provide sufficient friction for damping during the movement of the torque tube. The hard stop 606 of the coupling assembly 600 may restrict the rotational motion of the torque tube to an articulation range, e.g., ±60, ±75, or ±90, by engaging with edges 608a, 608b on the housing 602, which are configured to define the articulation range of the torque tube. The housing 602 may be installed on a pier 112 with suitable brackets, e.g., stamped metal brackets, and fasteners.

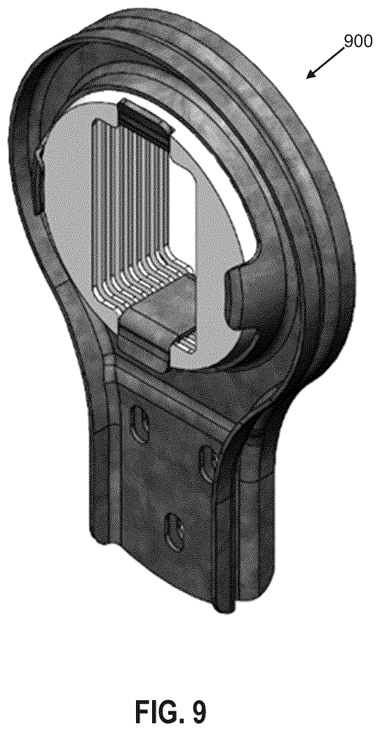

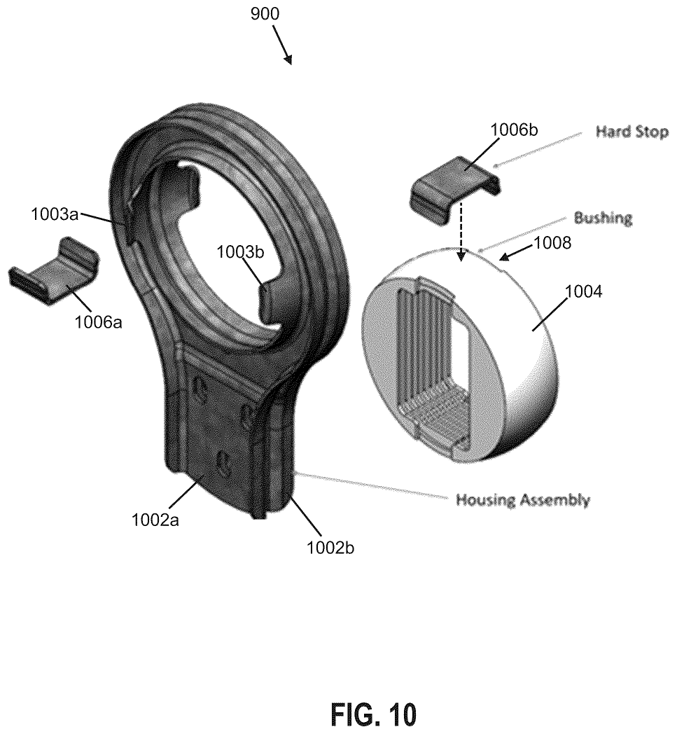

FIGS. 9-11B illustrate the structure and function of an example of a spherical torque tube coupling assembly 900 including bearing-clip hard stops 1006a, 1006b for use in the solar tracker 110 of FIG. 1. The spherical torque tube coupling assembly 900 includes a housing assembly 1002, a circular bearing 1004, and bearing-clip hard stops 1006a, 1006b. The housing assembly 1002 includes a first housing assembly member 1002a and a second housing assembly member 1002b, each having a circular aperture, a base including through holes for coupling the first and second housing assembly members 1002a, 1002b together and/or for coupling the housing assembly 1002 to a pier 112 using a suitable fastener including bolts and corresponding nuts. Alternatively, the base of the housing assembly 1002 may be coupled to a bracket (not shown), which, in turn, may be coupled to the pier 112. In one aspect, the spherical torque tube coupling assembly 900 is installed on the pier 112 with one or more stamped brackets and fasteners, which are passed through elliptical slots in the base of the spherical torque tube coupling assembly 900.

The circular bearing 1004 may be made of polymer material and may be used between the inside surface of the aperture of the housing assembly 1002 and the torque tube to have sufficient friction for damping during movement of the torque tube. The circular bearing 1004 may include an aperture having a geometry that matches the cross-section of the torque tube. For example, the cross-section of the torque may be any suitable cross-section including a circular, a rectangular, a hexagonal, an octagonal, a D-shape, a Triple D-shape, or a square cross-section.

The bearing-clip hard stops 1006a, 1006b are clipped on the outside surface of the circular bearing 1004 on opposite sides of the circular bearing 1004. The circular bearing 1004 may include notches 1008 that are shaped to enable the bearing-clip hard stops 1006a, 1006b to be pressure fit onto the circular bearing 1004.

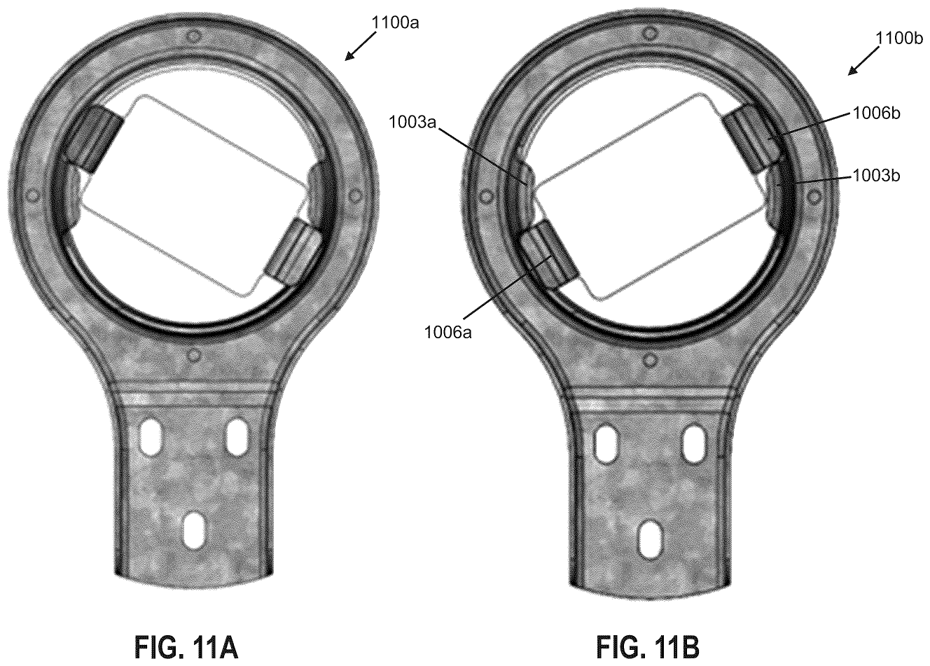

As shown in FIGS. 11A and 11B, the spherical torque tube coupling assembly 900 facilitates the movement of the torque tube through an articulation range of the solar tracker 110. When a maximum articulation is reached, the bearing-clip hard stops 1006a, 1006b engage with and stop at protruding portions 1003a, 1003b of the first and second housing assembly members 1002a, 1002b. The bearing-clip hard stops 1006a, 1006b and the protruding portions 1003a, 1003b of the first and second housing assembly members 1002a, 1002b may be configured and used to restrict the motion of the torque tube between suitable maximum angles, e.g., ±60°. The excess load is transferred to the foundation pile (not shown) through the spherical torque tube coupling assembly 900.

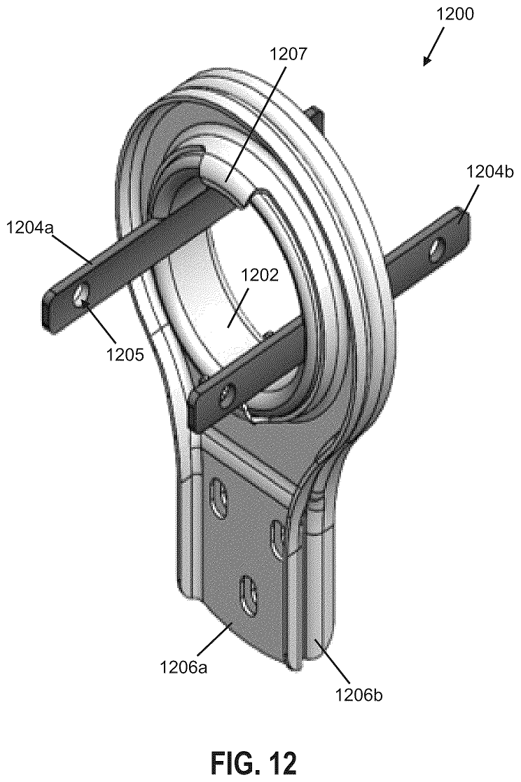

FIG. 12 illustrates an example of a spherical torque tube coupling assembly 1200 including link hard stops 1204a, 1204b for use in the solar tracker 110 of FIG. 1. The coupling assembly 1200 also includes a bushing 1202 and a housing assembly 1206 including a first housing assembly member 1206a and a second housing assembly member 1206b. The housing assembly 1206 may be made of any suitable metal or metal alloy. The first and second housing assembly members 1206a, 1206b may be formed by any suitable manufacturing method including stamping a metal or metal alloy sheet.

The bushing 1202 may be made of a polymer material, e.g., a plastic. The bushing 1202 may be disposed between an inside surface of an aperture of the first and second housing assembly members 1206a, 1206b and the outside surface of the torque tube to provide sufficient friction for damping during the movement of the torque tube. The inner geometry of the bushing 1202 may match the cross-section of the torque tube. For example, the cross-section may be any suitable cross-section including a circular, a rectangular, a hexagonal, an octagonal, a D-Tube, or a Triple D-tube cross-section.

The link hard stops 1204a, 1204b are coupled to an inside portion of the bushing 1202 on opposite sides and to a torque tube via the through holes 1205 in the link hard stops 1204a, 1204b. The link hard stops 1204a, 1204b may be fitted within a notch formed in inner portions of the bushing 1202. The link hard stops 1204a, 1204b on the coupling assembly 1200 are used to restrict the motion of the torque tube between maximum articulation angles, e.g., ±60°.

The coupling assembly 1200 may be installed on a pier 112 with brackets (not shown) using fasteners through the elliptical slots in the base of the bushing housing assembly 1206. The coupling assembly 1200 facilitates the movement of the torque tube through the articulation range of the solar tracker 110. When the maximum articulation is reached the link hard stops 1204a, 1204b engage with protruding members 1207 of the first and second housing assembly members 1206a, 1206b. The excess load is transferred to the foundation pile (not shown) through the coupling assembly 1200.

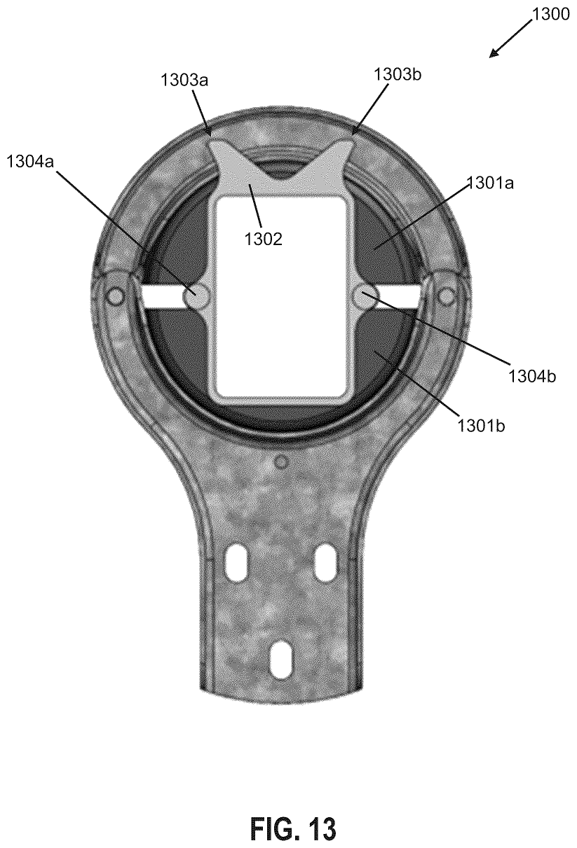

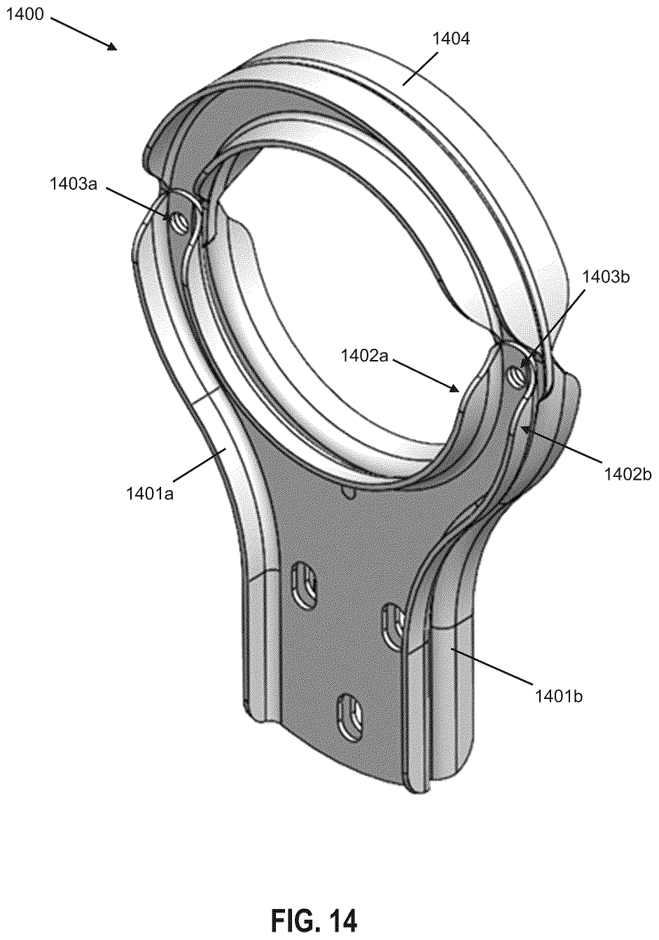

FIGS. 13 and 14 illustrate an example of a serviceable spherical torque tube coupling assembly 1300 for use in the solar tracker 110 of FIG. 1. The serviceable spherical torque tube coupling assembly 1300 includes a three-piece housing assembly 1400, a two-piece bearing assembly including bearing members 1300a, 1300b, and a pair of hard stops 1302.

The housing assembly 1400 includes first and second base members 1401a, 1401b and a top member 1404. End portions of the first and second base members 1401a, 1401b and the top member 1404 include through holes 1403a, 1403b, through which suitable fasteners may be used to couple the end portions of the top member 1404 to and between the end portions of the first and second base members 1401a, 1401b.

After installation, the top member 1404 may be removed by removing the suitable fasteners and lifting the top member 1404 off of the first and second base members 1401a, 1401b, thereby facilitating servicing of the coupling assembly 1300. The first and second base members 1401a, 1401b and the top member 1404 may be manufactured through one or more different methods including stamping. The first and second base members 1401a, 1401b include protruding members 1402a, 1402b configured to engage with the pair of hard stops 1302. The coupling assembly 1300 may be installed on a pier 112 with brackets (not shown), e.g., stamped brackets, with suitable fasteners placed through the elliptical slots in the lower portion of the first and second base members 1401a, 1401b.

The bearing members 1300a, 1300b forming a bearing assembly may be made of a polymer material. The bearing assembly is used between the aperture of the housing assembly 1400 and the torque tube to provide sufficient friction for damping during the movement of the torque tube. The inner geometry of the aperture of the bearing assembly may match the cross-section of the torque tube. The cross-section may be any cross-section including a circular, a rectangular, a hexagonal, an octagonal, a D-tube, or a Triple D-tube cross-section.

The hard stops 1302 couple to opposite sides of the bearing members 1300a, 1300b via pins 1304a, 1304b. The hard stops 1302 include protruding members 1303a, 1303b configured to engage with protruding members 1402a, 1402b at the end portions of the first and second base members 1401a, 1401b of the housing assembly 1400 to restrict the articulation range of the torque tube.

The coupling assembly 1300 facilitates the movement of the torque tube through the articulation range of the solar tracker. When the maximum articulation of the torque tube is reached, the protruding members 1303a, 1303b of the hard stops 1302 engage with the protruding members 1402a, 1402b at the end portions of the first and second base members 1401a, 1401b of the housing assembly 1400. The hard stop 1302 on the coupling assembly 1300 may be used to restrict the motion of the torque tube between ±60°. The excess load is transferred to the foundation pile (not shown) through the coupling assembly 1300.

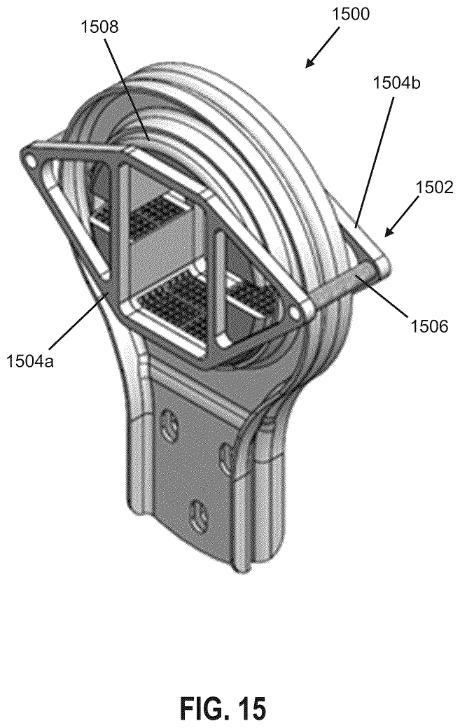

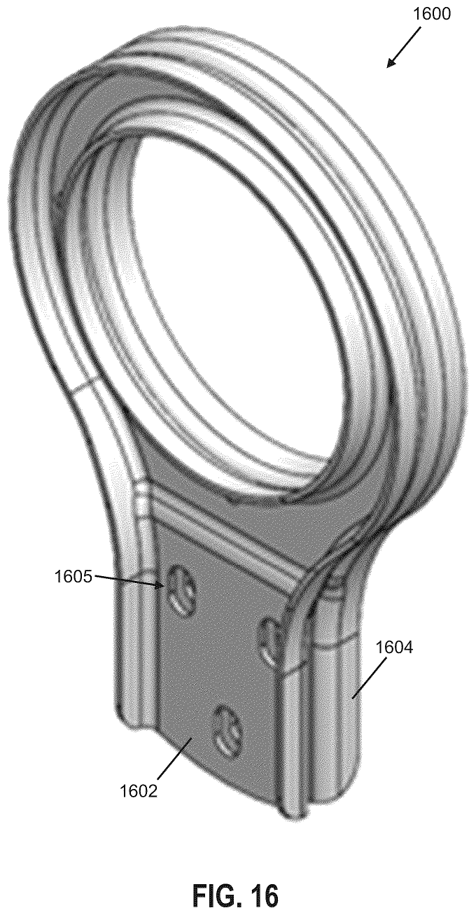

FIGS. 15 and 16 illustrate an example of a spherical torque tube coupling assembly 1500 including an external hard stop 1502 for use in the solar tracker 110 of FIG. 1. The external hard stop 1502 includes first and second hard stop structures 1504a, 1504b, which are coupled together by pins 1506 on opposite sides of the external hard stop 1502. The external hard stop 1502 is coupled to a ring bearing 1508, which may be made of a polymer material, and which may be configured as a two-piece bearing, to which the first and second hard stop structures 1504a, 1504b may attach via a suitable attaching method including welding, fastening, or adhesion, amongst others.

The coupling assembly 1500 facilitates the movement of the torque tube through the articulation range of the solar tracker 110. When the maximum articulation of the torque tube is reached the external hard stop, e.g., one of the pins 1506 engages with a portion of the housing members 1602, 1604 of the coupling assembly 1500. The excess load is transferred to the foundation pile (not shown) through the coupling assembly 1500.

The housing members 1602, 1604 may be manufactured through one or more different methods including stamping. The ring bearing 1508 is configured to be used between the aperture of the housing members 1602, 1604 and the torque tube to provide sufficient friction for damping during the movement of the torque tube. The inner geometry of the ring bearing 1508 may match the cross-section of the torque tube. The cross-section of the torque tube may be any cross-section including a circular, a rectangular, a hexagonal, an octagonal, a D-tube, or a Triple D-tube cross-section. The external hard stop 1502 of the coupling assembly 1500 may be used to restrict the motion of the torque tube between two maximum tracker angles, e.g., ±60°. Also, the coupling assembly 1500 may be installed on the pier 112 with brackets, e.g., stamped brackets, and fasteners, which may be passed through the elliptical slots 1605.

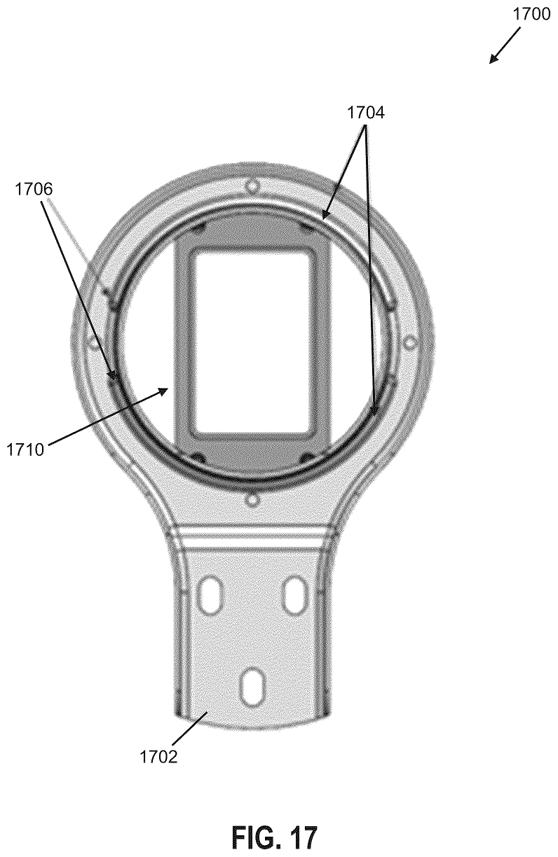

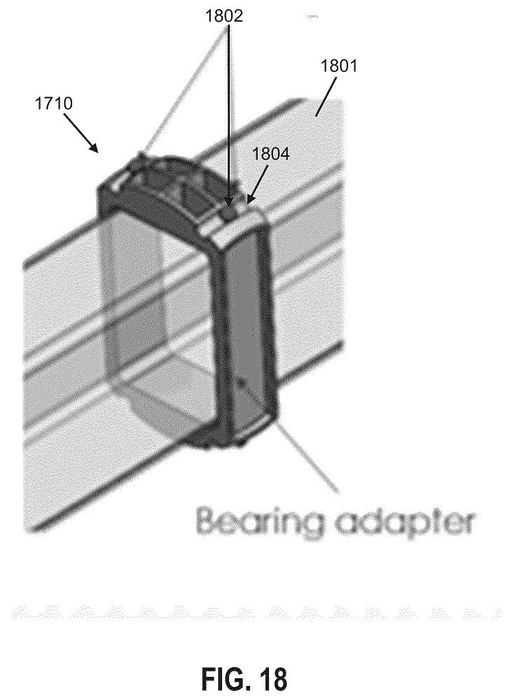

FIGS. 17 and 18 illustrate the structure and function of an example of a spherical torque tube coupling assembly 1700 including a non-frictional bearing adapter 1710 for use in the solar tracker 110 of FIG. 1. The spherical torque tube coupling assembly 1700 includes a housing 1702, and the non-frictional bearing adapter 1710, which rotates within an aperture of the housing 1702. The housing 1702 includes opposing ball bearing paths 1704, which include path hard stops 1706 at each end of the ball bearing paths 1704. The ball bearing paths 1704 are configured to guide movement of the ball bearings 1802 through the ball bearing paths 1704. The bearing adapter 1710 includes bearing races 1804 near the corners of the bearing adapter 1710 for the ball bearings 1802. In the bearing races 1804, the ball bearings 1802 may move parallel to the torque tube 1801.

The coupling assembly 1700 facilitates the movement of the torque tube 1801 through the articulation range of the solar tracker 110 and helps in the transfer of loads to the foundation pile (not shown). In aspects, any suitable type of ball bearing may be used. The bearing adapter 1710 moves relative to the housing 1702, e.g., a stamped metal housing, in such a way that the frictional resistance between the various components is minimal. The motion of the bearing adapter 1710 is restricted to tracking angle limits defined by the path hard stops 1706. In aspects, the tracking angle limits may be ±60°, ±75°, ±90°, or any other tracking angle limits suitable for a given solar tracker installation.

The housing 1702 may be manufactured through one or more of different methods including, for example, stamping. The bearing adapter 1710 may be made of polymer material suitable for use between the inner surface of the aperture of the housing 1702 and the torque tube 1801 to provide sufficient friction for damping during the movement of the torque tube 1801. The geometry of the aperture of the bearing adapter 1710 may match the cross-section of the torque tube 1801. The cross-section of the torque tube 1801 may be any cross-section suitable for operation of the solar tracker 110, including a circular, rectangular, hexagonal, octagonal, D-tube, or triple D-tube cross-section. The bearing adapter 1710 may be a split bearing adapter or a single-piece bearing adapter. The bearing races 1804 of the bearing adapter 1710 are provided to accommodate undulations of the torque tube 1801.

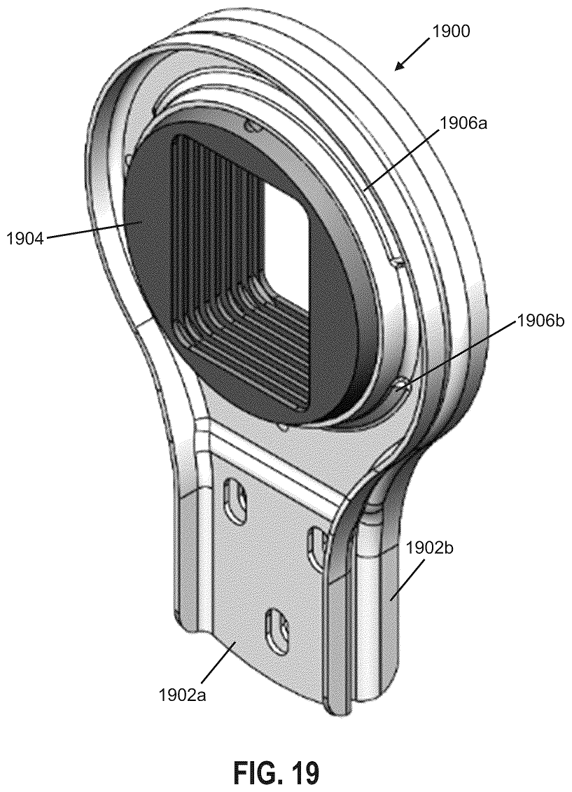

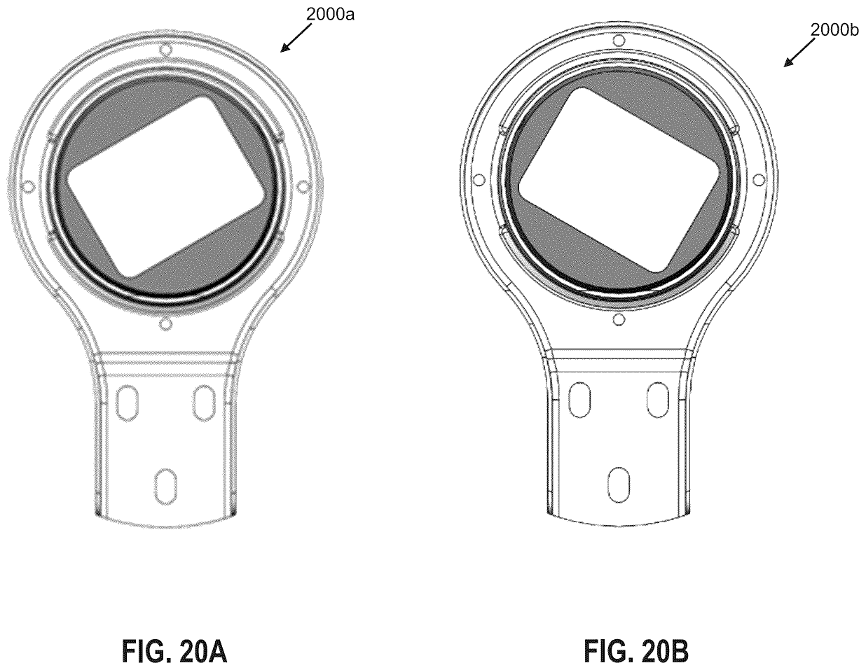

FIGS. 19-20B illustrate the structure and function of an example of a dual ball bearing torque tube coupling assembly 1900 for use in the solar tracker 110 of FIG. 1. The dual ball bearing torque tube coupling assembly 1900 includes a housing 1902, which may include a first housing member 1902a and a second housing member 1902b, and a bearing 1904, which rotates within an aperture of the housing 1902. Each of the first and second housing members 1902a, 1902b include opposing ball bearing paths 1906a, 1906b, which include path hard stops at each end of the ball bearing paths 1906a, 1906b. The ball bearing paths 1906a, 1906b are configured to guide movement of ball bearings (not shown), which may be disposed in races (not shown) formed in the outer surface of the bearing 1904, as the torque tube rotates the bearing 1904. In the races of the bearing 1904, the ball bearings 1802 may move parallel to a torque tube.

The dual ball bearing torque tube coupling assembly 1900 facilitates the movement of the torque tube through the articulation range of the solar tracker 110 and helps transfer loads to the foundation pile (not shown). The ball bearings may move relative to the housing 1902 and the bearing 1904 in such a way that the frictional resistance between the components is minimal. The motion of the ball bearing is restricted to the tracking angle limits, which, for example, may be ±60°. The hard stop paths 1906a, 1906b may be designed so the movement is restricted to the tracking angle limits by hard stops at the ends of the hard stop paths 1906a, 1906b.

The housing 1902 may be manufactured according to one or more different methods including stamping. For example, the first and second housing members 1902a, 1902b may be manufactured by stamping metal sheets with a stamp pattern suitable for forming the aperture of the housing 1902, the ball bearing paths 1906a, 1906, the fastener slots, and other features of the housing 1902.

The bearing 1904, which may be made of a polymer material, is used between the housing 1902 and a torque tube to provide sufficient friction for damping during the movement of the torque tube. The aperture geometry of the bearing 1904 may match the cross-section of the torque tube. The cross-section of the torque tube may be a circular, rectangular, hexagonal, octagonal, D-tube, or Triple D-tube cross-section.

The bearing 1904 may be a split bearing or a single-piece bearing. The bearing races and the ball bearing paths 1906a, 1906b are provided in the bearing 1904 and the housing 1902, respectively, to accommodate undulation. The dual ball bearing torque tube coupling assembly 1900 may also be configured to accommodate slope variations along the span of the solar tracker 110.

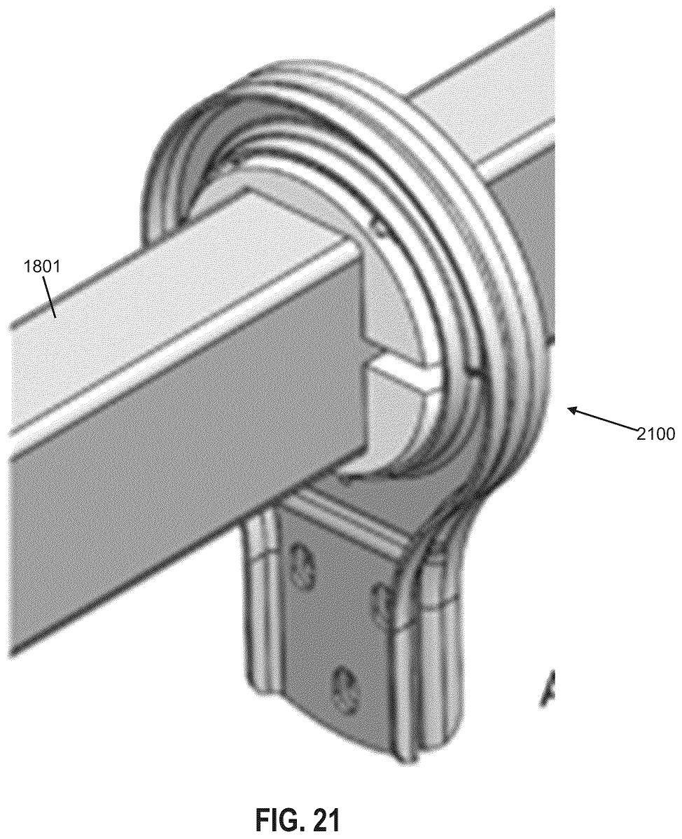

FIGS. 21-23B illustrate the structure and function of an example of a spherical torque tube coupling assembly 2100 including a non-frictional bearing 2300 for use in the solar tracker 110 of FIG. 1. The spherical torque tube coupling assembly 2100 also includes housing members 2208a, 2208b having circular apertures configured to fit around the non-frictional bearing 2300. The housing members 2208a, 2208b may be manufactured according to one or more different methods including stamping.

The bearing 2300 fits around the torque tube 1801. The bearing 2300 includes inserts 2202a, 2202b and corresponding inserts 2204, which are configured to be inserted into an aperture of each of the inserts 2202a, 2202b. The bearing 2300 also includes balls 2206, which are configured to fit within and move along the races 2205 of the inserts 2204. All or a portion of the bearing 2300 may be a split configuration or a single-piece configuration. For example, the inserts 2202a, 2202b may be configured as a single-piece.

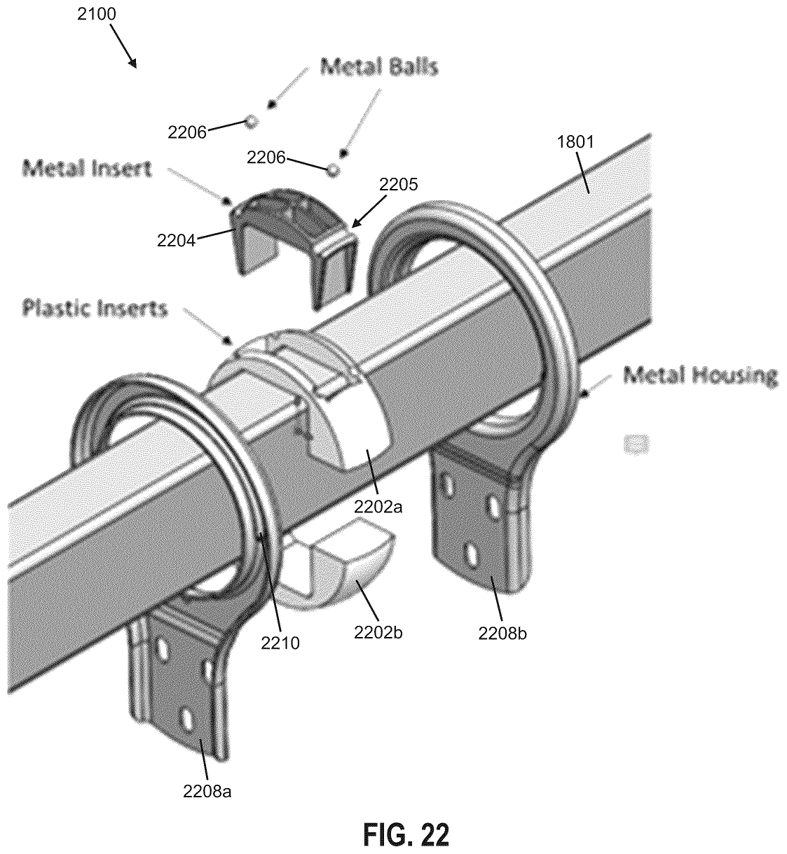

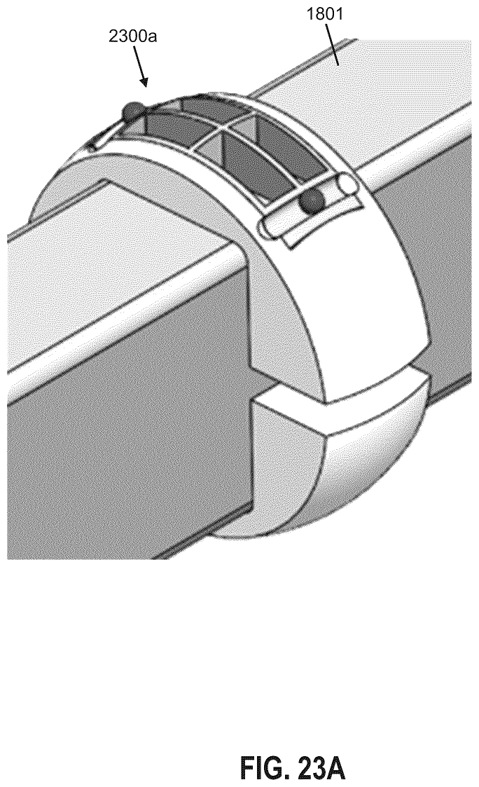

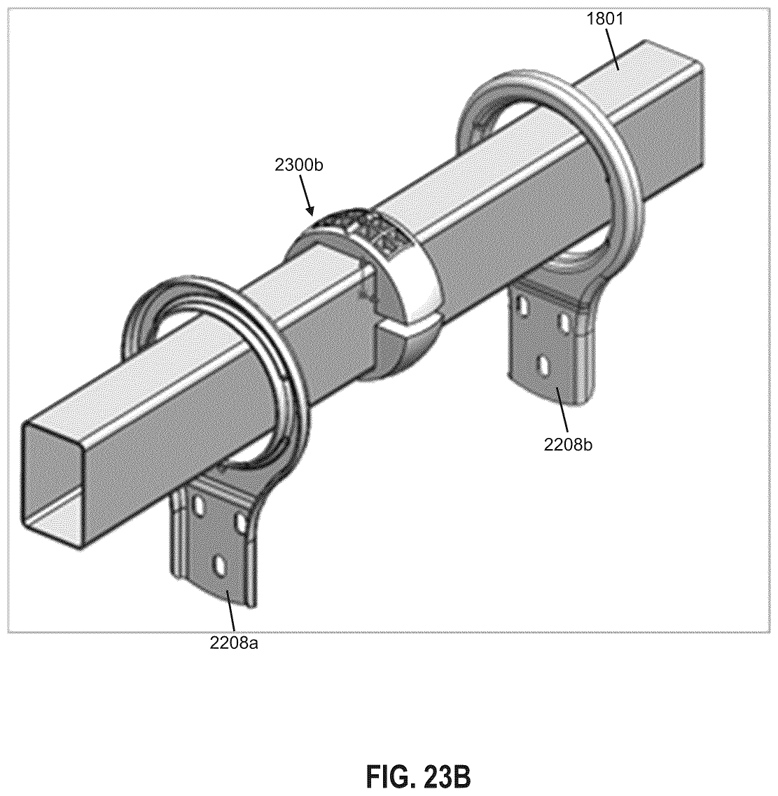

Single or multiple races 2205 may be provided on the ball bearing adapters 2300a, 2300b and on the inside surface of the aperture of the housing members 2208a, 2208b to accommodate for undulations. As shown in the bearing 2300a of FIGS. 22 and 23A, each insert 2204 may include a pair of races 2205. Each race 2205 of the pair of races 2205 receives one or more balls 2206, e.g., spherical ball bearings. Alternatively, as shown in the ball bearing adapter 2300b of FIG. 23B, each insert 2204 includes a single race, which is disposed in the middle of the insert 2204. Each race 2205 is configured to hold one or more balls 2206. Each of the inserts 2202a, 2202b may include walls that align with each race 2205 and prevent movement of balls 2206 outside of each race 2205.

The components of the bearing 2300 (e.g., the inserts 2202a, 2202b, the inserts 2204, and the balls 2206) may be made of a polymer material or a metallic material, or a portion of the components of the bearing 2300 may be made of a polymer material and the remaining components may be made of a metallic material. For example, the inserts 2202a, 2202b may be made of a plastic material, and the inserts 2204 and the balls 2206 may be made of the same or different metallic material.

The coupling assembly 2100 facilitates the movement of the torque tube 1801 through the articulation range of the solar tracker 110 and helps in the transfer of loads to the foundation pile (not shown). The balls 2206 move relative to the housing members 2208a, 2208b and the bearing 2300 in such a way that the frictional resistance between the components is minimal. The hard stop path 2210 is provided for the balls 2206 so that the movement of the bearing 2300 and torque tube 1801 is limited to the tracking angle limits. The motion of the balls 2206 may be restricted to tracking angle limits of ±60°.

The bearing 2300 may be made of a polymer material. The bearing 2300 is used between the housing members 2208a, 2208b, which may be made of a metallic material, and the torque tube 1801 to provide sufficient friction for damping during the movement of the torque tube 1801. The inner geometry of the plastic bearing may match the cross-section of the torque tube. For example, the cross-section may be any cross-section including a circular, a rectangular, a hexagonal, an octagonal, a D-tube, or a Triple D-tube cross-section.

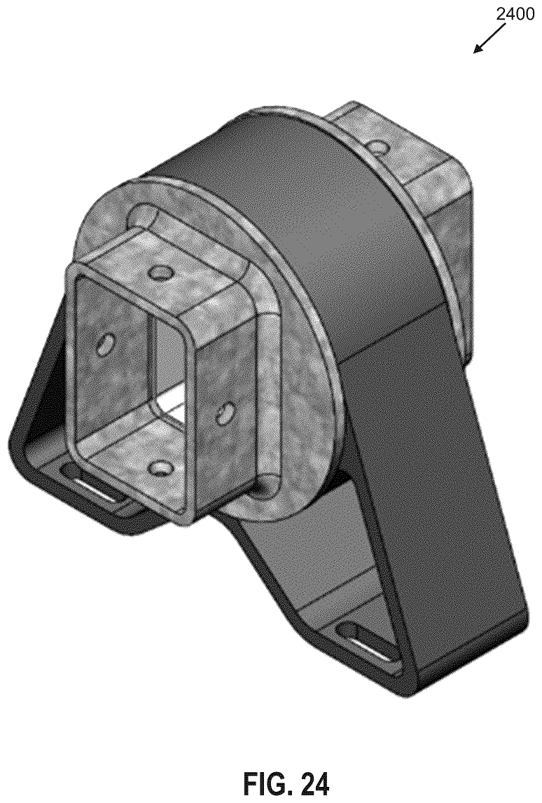

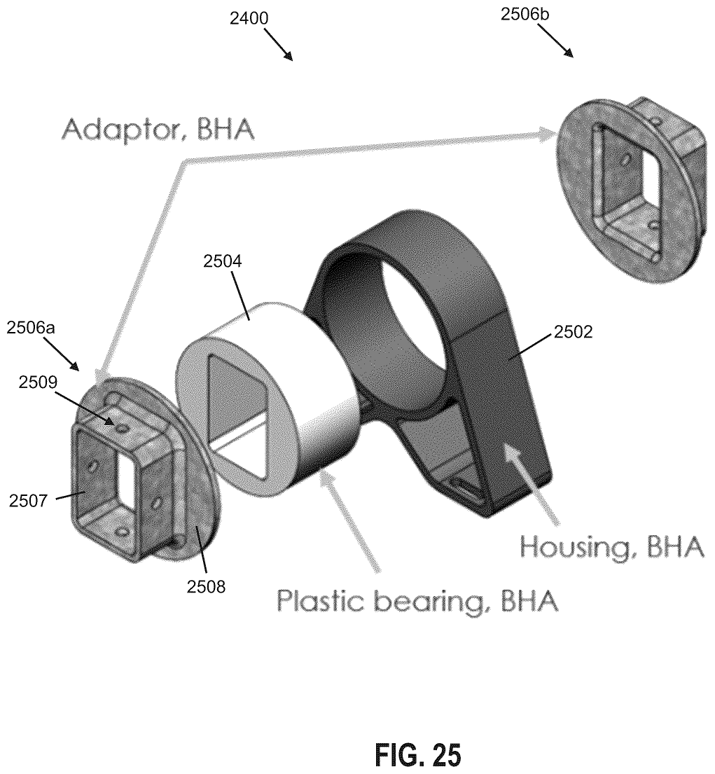

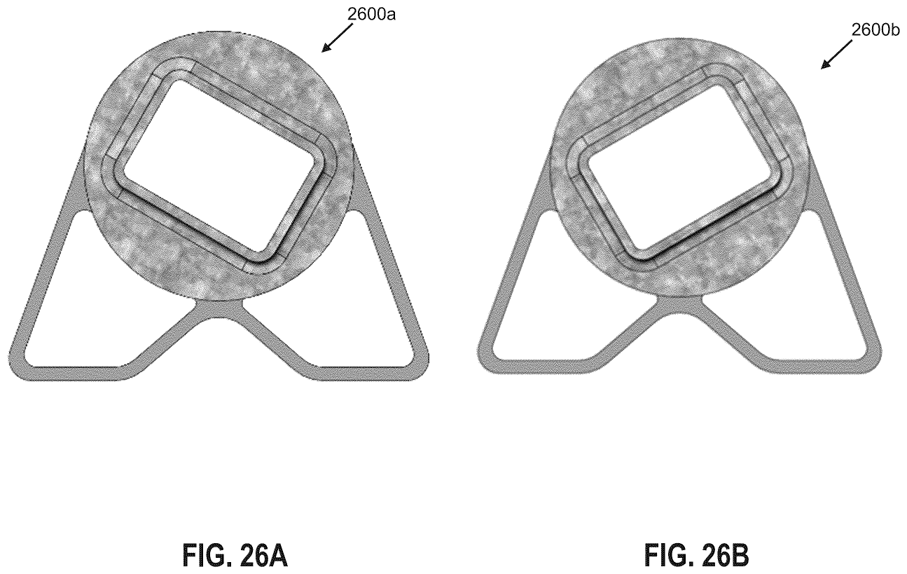

FIGS. 24-26B illustrate the structure and function of an example of a seismic-resistant torque tube coupling assembly 2400 for use in the solar tracker 110 of FIG. 1. The seismic-resistant torque tube coupling assembly 2400 includes a housing 2502 including a circular aperture, a circular bearing 2504 configured to fit and rotate within the circular aperture of the housing 2502, and a pair of adapters 2506a, 2506b, which are respectively coupled to the front and back sides of the circular bearing 2504 via flanges 2508 of the pair of adapters 2506a, 2506b. The housing 2502 may define a generally A-shaped configuration. Also, the housing 2502 may be manufactured through one or more different methods including stamping.

The bearing 2504 may be made of a polymer material. The bearing 2504 is used between the housing, which may be a metal or a metal alloy, and the torque tube to have sufficient friction for damping during movement of the torque tube. The inner geometry of the bearing 2504 may match the cross-section of the torque tube. The cross-section of the torque tube may be any suitable cross-section including a circular, a rectangular, a hexagonal, an octagonal, a D-tube, or a Triple-D tube cross-section. The bearing 2504 may be a split bearing or a single-piece bearing. The bearing 2504 may be coupled to the adapters 2506a, 2506b with one or more fasteners or adhesives suitable for causing the bearing 2504 to rotate along with the adapters 2506a, 2506b according to a commanded tracking angle within a tracking angle range, e.g., ±60°.

The one or more walls 2507 of the pair of adapters 2506a, 2506b may be configured to conform to the outer shape of the torque tube. The one or more walls 2507 of the pair of adapters 2506a, 2506b may also be configured to couple to the torque tube. For example, the one or more walls 2507 may include through holes 2509 through which a fastener may fixedly couple the pair of adapters 2506a, 2506b to the torque tube. The seismic-resistant torque tube coupling assembly 2400 may facilitate the movement of the torque tube 114 through the articulation range of the solar tracker 110 and facilitate the transfer of loads to the foundation pile (not shown).

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments.

Where possible, one or more of the above-described components may be formed as a unitary component by stamping, hydroforming, machining, additive manufacturing, amongst others, or in aspects, may be formed from one or more components joined together via welding, fasteners, adhesives, clinching, amongst others. For example, it is envisioned that the housing and/or bearing members of the multi-piece housing and/or bearing assemblies described herein may be coupled to one another via welding, adhesives, fasteners, and/or clinching, amongst others. It is also envisioned that the housing and/or bearing members of the multi-piece housing and/or bearing assemblies described herein may be formed from any suitable material, such as a metallic material, a non-metallic material, a composite, amongst others, and may be formed from one or more pieces of material using any suitable method such as stamping, hydroforming, additive manufacturing, welding, machining, adhesives, amongst others. In aspects, each of the housing and/or bearing members may be formed from the same or different material from one another, depending upon the design needs of the torque tube coupling assembly.

1. A coupling assembly for use with a solar tracker, the coupling assembly comprising:
a housing including a circular aperture and protrusions extending from the housing;
a bearing configured to fit within the circular aperture and to rotate within the circular aperture of the housing, the bearing including an aperture having a shape of a cross-section of a torque tube; and
at least one hard stop configured to engage with the protrusions and limit motion of the bearing.

2. The coupling assembly according to claim 1, wherein the housing is a stamped metal sheet.

3. The coupling assembly according to claim 2, wherein the shape of the cross-section of the torque tube is a circular shape, a rectangular shape, a hexagonal shape, an octagonal shape, a D-shape, a triple D-shape, or a square shape.

4. The coupling assembly according to claim 1, wherein that at least one hard stop is a wrench-type hard stop that couples to a side surface of the bearing or a bearing-clip hard stop that clips across an outside surface of the bearing.

5. The coupling assembly according to claim 1, wherein the at least one hard stop is a link hard stop that is configured to couple to the torque tube.

6. The coupling assembly according to claim 1, wherein the housing includes a first base member and a second base member defining a first arc, and a top member defining a second arc, and
wherein end portions of the top member are configured to couple between the first base member and the second based member to form an aperture.

7. A coupling assembly for use with a solar tracker, the coupling assembly comprising:
a housing including a circular aperture, a pair of opposing ball bearing paths disposed along an inner surface of the circular aperture, and hard stops at end portions of the pair of opposing ball bearing paths;
a bearing configured to fit within the circular aperture and to rotate within the circular aperture of the housing, the bearing including an aperture having a shape of a cross-section of a torque tube, the bearing including ball bearing races in an outer surface of the bearing; and
ball bearings disposed between the ball bearing paths and the ball bearing races.

8. The coupling assembly according to claim 7, wherein the bearing is made of a polymer material.

9. The coupling assembly according to claim 7, wherein the housing includes a first housing member and a second housing member, each including opposing pairs of ball bearing paths and hard stops at end portions of the ball bearing paths.

10. The coupling assembly according to claim 9, wherein the bearing is a split bearing or a single-piece bearing.

11. The coupling assembly according to claim 7, wherein the housing includes a first housing member and a second housing member configured to be coupled together.

12. A seismic resistant coupling assembly for use with a solar tracker, the seismic resistant coupling assembly comprising:
a housing having an A-shaped profile, the housing including a circular aperture and a pair of mounting feet;
a bearing configured to fit within the circular aperture and to rotate within the circular aperture of the housing, the bearing including an aperture having a shape of a cross-section of a torque tube; and
a pair of adapters including walls defining an aperture and a flange configured to couple to opposite sides of the bearing, the aperture having a shape of the cross-section of a torque tube, an inner portion of the walls configured to couple to a torque tube.

13. The seismic resistant coupling assembly according to claim 12, further comprising a link hard stop that is configured to couple to the torque tube,
wherein the housing includes protruding members configured to engage with the link hard stop and prevent further motion of the torque tube.

14. The seismic resistant coupling assembly according to claim 12, wherein the shape of the cross-section of the torque tube is a circular shape, a rectangular shape, a hexagonal shape, an octagonal shape, a D-shape, a triple D-shape, or a square shape.

15. The seismic resistant coupling assembly according to claim 12, wherein the housing is made of a metallic material, and
wherein the bearing is made of a polymer material.
